(19) United States
(12) Patent Application Publication
(10) Pub. No.: US 2011/0310736 A1
(43) Pub. Date: Dec. 22, 2011

(54) Method And System For Handling Traffic In A Data Communication Network

(75) Inventors: Sahil P. Dighe, Salt Lake City, UT (US); Joseph F. Olakangil, Midvale, UT (US)

(73) Assignee: Alcatel-Lucent USA Inc., Murray Hill, NJ (US)

(21) Appl. No.: 12/816,871

(22) Filed: Jun. 16, 2010

(51) Int. Cl. H04L 12/26

(52) U.S. Cl. 370/235

(57) ABSTRACT

A method and system for offloading data traffic routing from one NI (network interface) to another in a multi-NI platform. When an NI determines that offloading of data traffic should occur, it disables routing at the incoming port or ports on which L3 traffic may be received, and reconfigures an L2 table to indicate that traffic addressed to a router MAC address should not be routed, but instead bridged to the other NI. This bridging is preferably done using an inter-NI link that is dedicated for communication between two or more NIs in the multi-Ni platform. The determination to offload traffic may, in some embodiments, be made as part of an initialization sequence and offloading is used until synchronization of the NI has been completed to a pre-determined point, at which time a determination is made to terminate offloading and routing from the NI is re-enabled.

### TECHNICAL FIELD

The present invention relates generally to the field of data communication networks, and, more particularly, to a system and method for handling traffic in such a network by offloading routing traffic from one NI (network interface) in a multi-NI routing platform to another when necessary or desirable, for example during the NI synchronization process.

### BACKGROUND

The following abbreviations are herewith defined, at least some of which are referred to within the following description of the state-of-the-art and the present invention.
ARP Address Resolution Protocol
CPU Central Processing Unit
IEEE Institute of Electrical and Electronics Engineers
IP Internet Protocol
L2 Layer 2 (data link layer of the OSI reference model)
L3 Layer 3 (network layer of the OSI reference model)
LAN Local Area Network
MAC Media Access Control
NI Network Interface
OSI Open Systems Interconnection
PC Personal Computer
TCP Transmission Control Protocol
VLAN Virtual LAN

Computers may be connected to one another though a computer network, for example a LAN (local area network) implemented by an enterprise. Computers connected together in this way may share data and computing resources. The LAN or other network may be small, consisting of only a few computers and networking devices, or it may be very large, as in the case of a large company, university, or government agency. It may be isolated—that is, capable of communicating only within the network itself—but more typically modern networks are interconnected with other networks such as the Internet as well.

Data transmitted to and from the computers in a network is segmented at the transmitting device into discrete units such as packets or frames. Each unit of data traverses the network, or a number of networks, before reaching its intended destination. The receiving device can then reassemble the data for processing or storage. In most instances, the data units do not travel directly from the sending to the receiving devices, but are transmitted via a number of intermediate nodes such as bridges, switches, or routers.

To ensure the proper transmission of data units, standard protocols have been developed. For example, Ethernet is a layer 2 protocol used by many LANs. “Layer 2” is a reference to the data link layer of the OSI model. The OSI model is a hierarchical description of network functions that extends from the physical layer 1 to application layer 7. The MAC (media access control) layer is considered part of layer 2. In MAC bridging, the MAC addresses that are assigned to each node are “learned” so that intermediate nodes come to associate one of their ports with one or more MAC addresses. When a frame of data is received it includes a destination MAC address and is forwarded, or “bridged”, on the appropriate port.

TCP/IP is a layer 3, or network layer protocol. A received data packet includes an IP (Internet protocol) address that is read by a device such as a router, which is in possession of information enabling the router to determine a path to the destination node and route the packet accordingly. Although layer 3 routing is somewhat more involved, and in some cases slower than layer 2 bridging, there are situations in which it is advantageous or necessary. Many modern network nodes perform both bridging and routing functions.

One such device is an NI (network interface—sometimes referred to as an NI card), which in many networks may be positioned, for example, to directly communicate with another network or with a user device such as a PC or laptop. The routing function of the NI maybe used, for example, to direct received packets to a specific subnetwork or VLAN (virtual LAN) within the network itself. Many NIs may be in communication with given network. In some cases, multiple NIs may be interconnected and even housed in the same physical chassis.

For various reasons, an NI may experience an outage, or shutdown, such as when it breaks down or is replaced. During an outage, the NI's knowledge of routing paths throughout the network is often lost, and must be re-gathered during restart in a process sometimes called synchronization. Unfortunately, this may take time some time, and during this period received traffic that would otherwise have been routed is simply dropped. While the some network protocols may provide for the eventual retransmission of dropped packets, this introduces both delay and the inefficient use of network resources. A manner of minimizing the number of dropped packets would therefore be of great advantage.

Accordingly, there has been and still is a need to address the aforementioned shortcomings and other shortcomings associated with data traffic handling in certain situations, such as an NI initialization. These needs and other needs are satisfied by the present invention.

### SUMMARY

The present invention is directed to a manner of handling data traffic, and specifically to a manner of offloading data traffic routing from one NI (network interface) to another in a multi-NI platform.

In one aspect, the present invention is a method for handling data traffic in a multi-NI routing platform including determining that L3 traffic should be offloaded from a first NI of the routing platform, disabling L3 routing in the first NI, configuring the first NI to bridge incoming L3 data traffic on a port associated with a second NI of the routing platform, and configuring the second NI to route L3 traffic received on a port associated with the first NI. The method may further include determining the offloading of data traffic is no longer necessary, and reconfiguration of the first NI to enable it to route the L3 data traffic received on the ports of the first NI.

In a preferred embodiment, the first NI and the second NI are housed in a single chassis, and connected by an inter-NI link, which link may include one or more physical links.

In another aspect, the present invention is a system for handling data traffic in a multi-NI platform, including a first NI configured to determine that L3 routing traffic received in the first NI should be offloaded, a second NI configured to receive and route L3 routing traffic bridged from the first NI, and a communication link between the first NI and the second NI for carrying the bridged traffic. The first NI disables routing upon determining that L3 routing traffic should be off-loaded and updates a first NI L2 table to associate a port of the communication link with a router MAC address. In some embodiments, communication between the first NI and the second NI takes place over a virtual inter-NI link including a plurality of physical links.

In yet another aspect, the present invention is a NI configured to determine that received L3 data traffic should be offloaded by disabling L3 routing and configuring an L2 table to bridge routing traffic to at least one other NI for routing. The NI may further include an offload message generator for generating an offload message to notify the at least one other NI to expect the bridged traffic. The NI may further be configured to determine that offloading should be terminating and to re-enable routing from the NI.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is a schematic diagram illustrating selected components of a multi-NI chassis and associated components of a data communication network in which an embodiment of the present invention may be advantageously implemented;

FIG. 2 is a flow diagram illustrating a method for handling data traffic in a multi-NI platform environment according to an embodiment of the present invention;

FIG. 3 a flow diagram illustrating a method for handling data traffic in a multi-NI platform according to another embodiment of the present invention;

FIG. 4 is a simplified block diagram illustrating selected components of a multi-NI routing platform in a first state according to the embodiment of FIG. 3;

FIG. 5 is a simplified block diagram illustrating selected components of a multi-NI routing platform in a second state according to the embodiment of FIG. 3; and

FIG. 6 is a simplified block diagram illustrating an NI conFigured according to an embodiment of the present invention.

### DETAILED DESCRIPTION

The present invention is directed to a manner of handling incoming traffic for an NI operating in a multi-NI environment. Operation of the present invention advantageously provides a manner of offloading traffic from one NI to another, which may be advantageous, for example, during the process of synchronizing the offloading NI in an effort to reduce the amount of dropped data traffic.

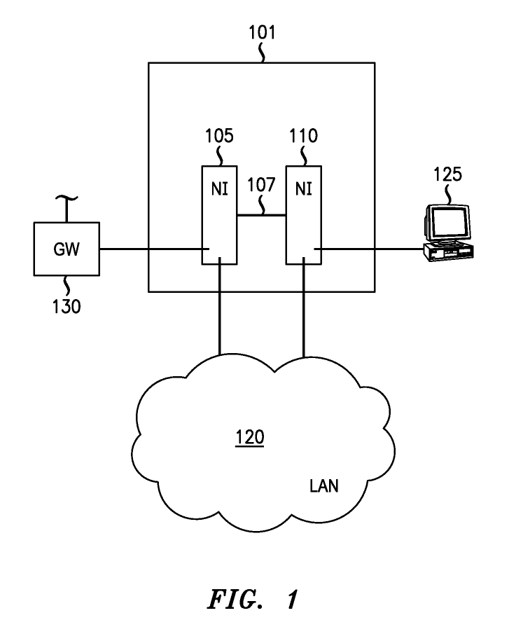

FIG. 1 is a schematic diagram illustrating selected components of a multi-NI chassis 101 and associated components of a data communication network in which an embodiment of the present invention may be advantageously implemented. As might be expected, the multi-NI platform is used in environments where a single NI might be inadequate, or where the security of redundancy is desired. In this embodiment, NI 105 and NI 110 are shown housed together in a single chassis 101, although in other embodiments they might be physically separated, for example residing in different chassis. In other words, a multi-NI platform according to the present invention may be but is not necessarily implemented in a single-chassis configuration.

For purposes of illustration, NI 105 is shown connected to a gateway 130, which in turn communicates with another network (for example, the Internet; not shown). NI 110, on the other hand, is shown in communication with a single user device 125. In this embodiment, both NI 105 and NI 110 are also in direct communication with a LAN 120. LAN 120 may be expected to include a number of user devices and other components, although these are not separately shown. This configuration is of course exemplary rather than limiting.

In the embodiment of FIG. 1, NI 105 and NI 110 are directly connected to each other by an inter-NI link 107. Although NI 105 and N 110 may also be able to communicate with each other in some other fashion, for example, via LAN 120, the inter-NI link 107 provides a reliable and generally-speaking less congested communication link. It is noted, however, that there may be more than two NIs in a given chassis or other multi-NI platform, in which case the inter-NI link or links may serve more then two NIs. In some embodiments, however, a dedicated inter-NI link may be provided between two NIs even though other NIs are also present.

Returning to the embodiment of FIG. 1, in accordance with this embodiment of the present invention, either or both of the two NIs 105 or 110 are configured to off-load their routing traffic to the other. For example, NI 105 may receive traffic from gateway 130 that needs to be routed, but instead of performing the routing function itself, NI 105 bridges this traffic to NI 110, which performs the routing function for the data traffic it receives from NI 105 as well as for routing traffic, if any, it receives from other sources.

This may be advantageously used, for example, when NI 105 is undergoing synchronization after initialization. During at least part of the synchronization process, NI 105 may need to learn the switch configuration, routes, ARPs, and other information used in the routing process. This information is often lost, for example, during an outage of NI 105. As mentioned above, during this learning process, packets received at NI 105 may simply be dropped. The off-loading method of the present invention attempts to prevent or mitigate this packet loss. In some embodiments, off-loading according to the present invention may last for extended periods of time, for example when NI 105 lacks routing capability. In this way a network operator may save the costs of providing routing capability in all network NIs. The off-loading process according to the present invention will now be described in greater detail.

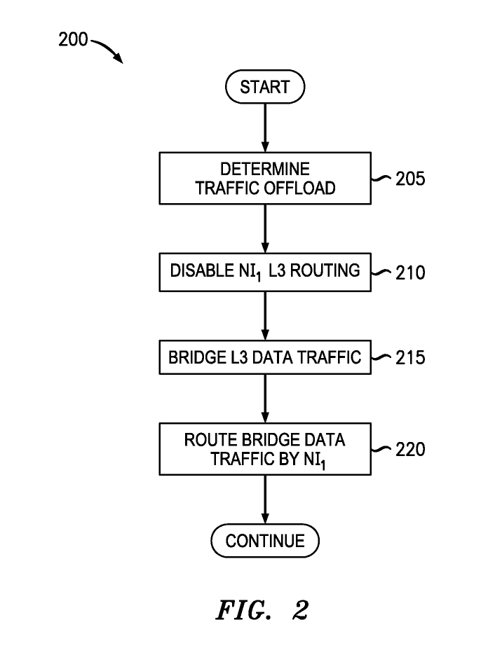

FIG. 2 is a flow diagram illustrating a method 200 for handling data traffic in a multi-NI platform environment according to an embodiment of the present invention. At START it is presumed that the components necessary to performing the method 200 are available and operational. The process then begins with a determination (step 205) that the traffic off-load should occur. This determination is typically but not necessarily made in the restarting NI itself. For purposes of illustration this NI will be referred to as NI₁. In most cases this determination is made as part of the initialization process, after some functionality has been restored to NI₁, but before synchronization sufficient for routing has been completed.

In the embodiment of FIG. 1, when the determination is made at step 205 that the data traffic off-load should commence, L3 (layer 3) routing is disabled (step 210) in NI₁ so that futile or unwanted attempts at routing from NI₁ do not occur. Data traffic that is to be routed is then bridged (step 215) to a second NI, here referred to as NI₂. In a preferred embodiment, this traffic is bridged on a port associated with an inter-NI link dedicated for communication between NI₁ and NI₂. In another preferred embodiment, the inter-NI link may support communication with additional NIs as well. The packets for routing received in NI₂ on a port from NI₁ are then routed (step 220) toward their intended destination by NI₂. The process then continues until a change in the system configuration occurs.

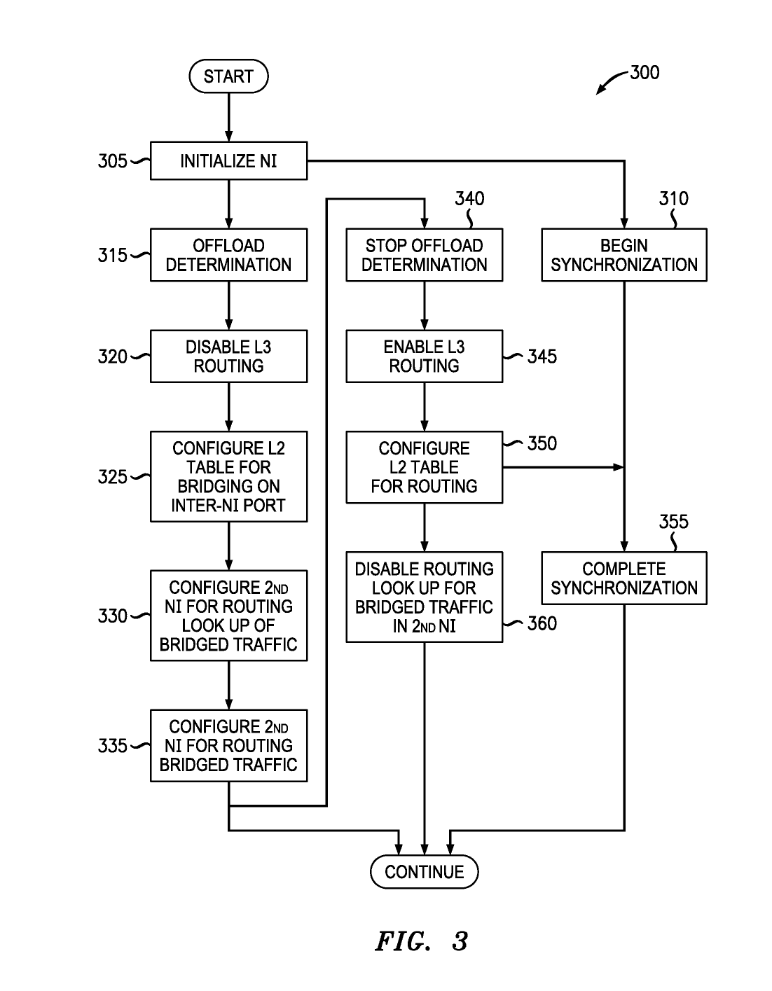

FIG. 3 a flow diagram illustrating a method 300 for handling data traffic in a multi-NI platform according to another embodiment of the present invention. At START it is presumed that the components necessary for performing method 300 are available and operational. The process then begins when an initialization of a first NI of the multi-NI platform is commenced (step 305). In most cases, this initialization will be performed as the result of an outage, planned or unplanned, but may be initialized for other reasons as well. In a preferred embodiment, the restart procedure is configured in hardware, for example in an ASIC. Successful results have been achieved, for example, using a Broadcom® BCM56630chipset. Note that the initialization procedure may also be used for the initial startup of an NI; no particular pre-initialization state is implied by the use of this term.

As used herein, “initialization” includes the start or restart (or reboot) of an NI generally to the point where an embodiment of the present invention may be executed, or at least initiated. Similarly, “synchronization” of an NI refers generally to the portions of the startup or restart process necessary to route L3 data traffic. As should be apparent, these definitions are for the sake of clarity and convenience, and not meant to otherwise imply a precise condition or state of the NI or related components. There may be an election, for example, to offload traffic at some later point during a restart, or cease offloading earlier, than is described in reference to the embodiment of FIG. 3. In the embodiment of FIG. 3, synchronization is begun (step 310) when the NI has been initialized at step 305.

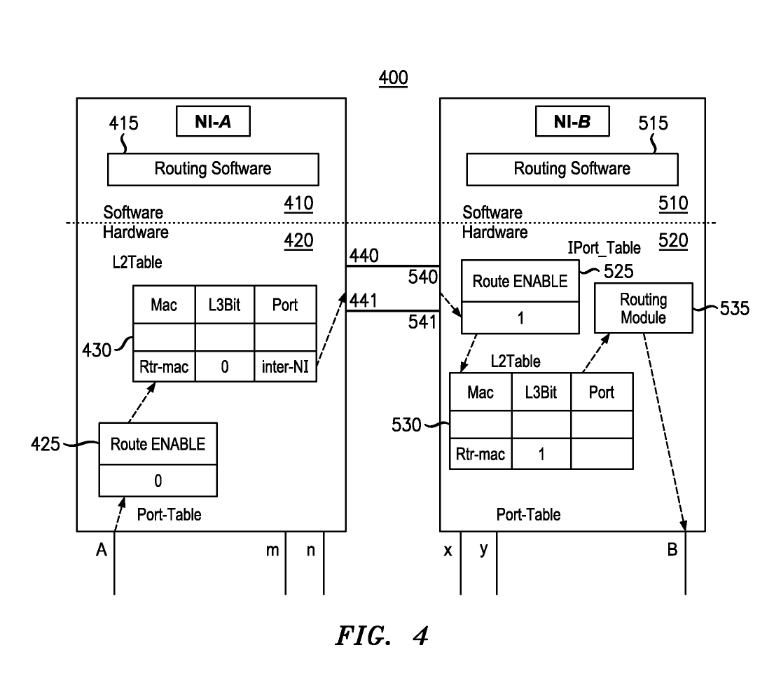

In this embodiment, the first NI also then determines (step 315) whether received routing traffic should be off-loaded. Usually this determination will take place as part of the restart procedure itself but in some cases the determination will be made in a different context. For example, an off-load determination may be indicated by a network operator prior to performing some maintenance operation. Returning to the embodiment of FIG. 3, when an off-load determination has been made at step 315, routing by the first NI is disabled (step 320) by an appropriate indication in the port table or tables associated with any port on which routing traffic may be expected. In an implementation using the BCM56630 referred to above, for example, the V4L3_ENABLE and V6L3_ENABLE bits are set to 0 (off). (See, for example, NI-A of FIG. 4.)

In the embodiment of FIG. 3, the L2 table is then configured (step 325) so that traffic addressed to a router-MAC address associated with the multi-NI platform and received in the first NI is bridged to a second NI. The bridge is preferably made over an inter-NI link between the first and second NI (and often connecting to any other NIs of the multi-NI platform as well). In an implementation using the BCM56630™, for example, this may be from a HiGig™ port of the first NI to a HiGig™ port on the second NI. This L2 table configuration may be accomplished by adding an entry for the router-MAC, which is associated (“learned”, which herein includes configured, as necessary, during execution of the method of the present invention) with a port corresponding to the inter-NI link (for example, a HiGig™ port). Note that the inter-NI link may include more than one physical links, and, if so, more than one port of the first NI. In this case, a particular port may be selected for this purpose, either at the time of offloading or as determined in advance. In most embodiments, the normal process of the NI for allocating inter-NI traffic may be used. In step 325, if an L3 bit is present on the L2 table, it is set to 0 (off) for the router-MAC address entry.

Note here that the determination to begin off-loading (for example at step 315) may be communicated to the second NI via the transmission of an offload message (not shown) so that the second NI may perform whatever configuration steps are necessary to route the L3 data traffic that is bridged from the first NI. In another embodiment, transmission of an offload message is not necessary as each NI (or at least the relevant NI) is always able to handle bridged traffic, either as part of a pre-set configuration or as automatically configured when bridging L3 traffic is detected.

In the embodiment of FIG. 3, the port table associated with the port of the second NI on the inter-NI link is configured (step 330) to perform L3 routing lookups with respect to routing traffic bridged from the first NI. In an implementation using the BCM56630 referred to above, for example, the V4L3_ENABLE and V6L3_ENABLE bits are set to 1 (on). The L2 hardware table of the second NI is configured (step 335) to indicate that traffic addressed to the router-MAC address should be routed by the second NI. For example an entry may be made associating the router-MAC address with a CPU port, and an L3 routing flag may be set. (See, for example, NI-A of FIG. 4.) Note that in some instances, the configuration of NI-B does not necessarily represent a re-configuration. The L3 bit, for example, may have already been in the desired setting.

Transformed in this manner, the multi-NI platform is able to offload routing traffic from the first NI for routing by the second NI. This continues for so long as desired, for example when the end of the initialization procedure for the first NI approaches. Of course, other factors may be taken into account when making this determination.

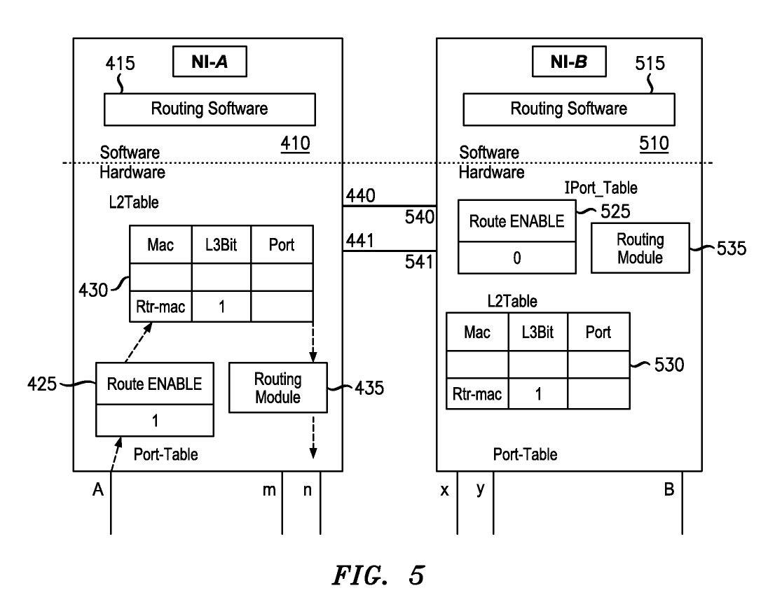

In the embodiment of FIG. 3, when a determination is made (step 340) that offloading is no longer required, routing by the first NI is enabled (step 345) by an appropriate indication in the port table or tables associated with any port on which routing traffic may be expected. In an implementation using the BCM56630 referred to above, for example, the V4L3_ENABLE and V6L3_ENABLE bits are set to 1 (on). To return the first NI to its normal operating configuration, the L2 is reconfigured (step 350) to have the first NI act as a routing node. In this embodiment, this includes modifying the router MAC entry in the L2 table to have been learned, that is, configured on a CPU port 0, and setting the L3 routing flag to 1 (on). (See, for example, NI-A of FIG. 5.)

In the embodiment of FIG. 3, the determination that offloading should be terminated and the reconfiguration of the various hardware tables is performed as part of, or at least in parallel with, the synchronization procedure. In this embodiment, the synchronization procedure is completed (step 355) when this reconfiguration has been accomplished. In this embodiment, the second NI is also returned to normal operating configuration. Specifically, the port table associated with the inter-NI link is reconFigured (step 360) such that routing lookups for traffic received on this link are no longer performed. In an implementation using the BCM56630 referred to above, for example, the V4L3_ENABLE and V6L3_ENABLE bits are set to 0 (off).

Here it is noted that while some of the operations of method 300 are similar or analogous to those of method 200 described above in reference to FIG. 2, they are different embodiments of the present invention and operations of one are not necessarily present in the other by implication. Note also that the sequence of operations depicted in FIGS. 2 and 3 are exemplary; these operations may occur in any logically-consistent sequence in other embodiments. Finally, note that additional operations may be performed in either sequence, and in some cases operations may be subtracted, without departing from the spirit of the invention.

The port tables and the L2 table are in these embodiments are preferably implemented in hardware. An exemplary implementation is illustrated in FIGS. 4 and 5. FIGS. 4 and 5 are simplified block diagrams illustrating selected components of a multi-NI routing platform 400 in, respectively, a first and second configuration state, according to the embodiment of FIG. 3.

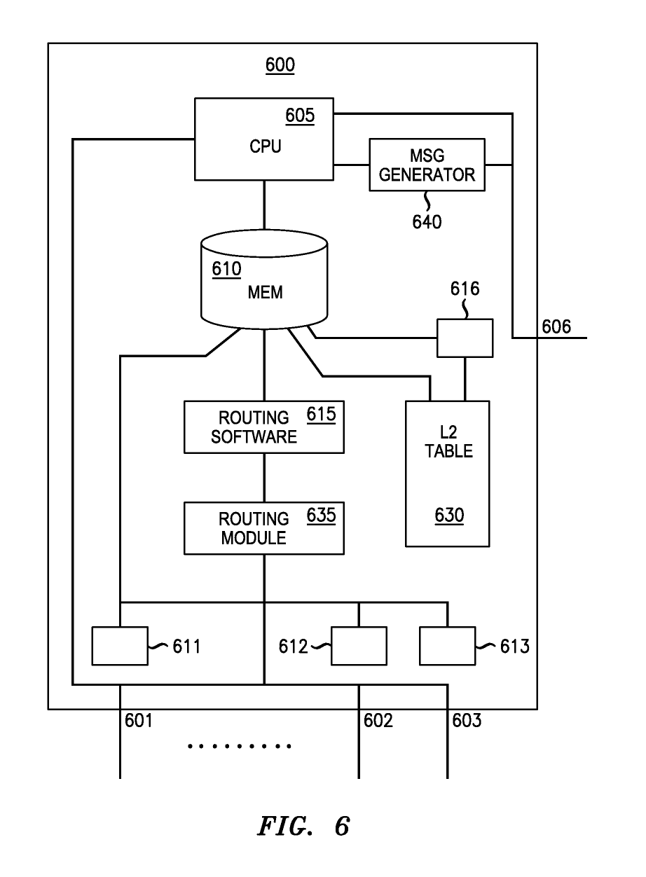

In this embodiment, a first NI is referred to as NI-A, and is represented as having a software portion 410 and a hardware portion 420. A CPU and a memory device (see FIG. 6) are usually present in each NI but not shown in FIGS. 4 and 5. The software portion 410 includes routing software 415 for performing the actual L3 routing, but in this embodiment no software modifications are contemplated except those necessary to support the hardware transformation described herein. In other embodiments some or each of these operations may also be implemented in a combination of hardware and software.

Returning to the embodiment of FIGS. 4 and 5, represented in FIG. 4 is a port table 425 associated with port A. Ports m and n are also illustrated, but omitted for clarity are any internal features associated with them. As can be seen in FIG. 4, the port table associated with port A of NI-A has a route ENABLE bit set to 0. As alluded to above, in an implementation using the BCM56630 or similar chipset, this is representative of the V4L3_ENABLE and V6L3_ENABLE bits set to 0 (off). No routing lookups are performed in NI-A for routing traffic received on port A in this configuration. In addition, the L2 hardware routing table 430 is configured with a router-MAC entry associated with an L3 routing bit set at 0 and the inter-NI port of NI-A. As mentioned above, the inter-NI port in the BCM56630 chipset is sometimes referred to as a HiGig™ port. In this configuration state, all routing traffic received, for example, at port A is bridged on the inter-NI port 440 as represented by the broken lines and arrowheads in FIG. 4. Note again that the inter-NI connections may actually be implemented in more than one link, as implied by port 441 in FIG. 4. In this embodiment, there are two such links making up the inter-NI connection between NI-A and NI-B, but in other embodiments there may be more or fewer links present. Whether the bridged data traffic is sent on only one of the links or on more than one is a matter of choice in the individual implementation.

Also shown in FIG. 4 is NI-B, which analogous to NI-A includes a software portion 510 and a hardware portion 520. The software portion 510 of NI-B likewise includes routing software 515. In this configuration, representing the first state where NI-A is offloading routing traffic to NI-B, a port table 525 associated with the inter-NI link ports has a route ENABLE bit set to 1 (on). In an implementation using the BCM56630 or similar chipset, port table 525 may be referred to as an IPort_Table (as in FIG. 4) and is representative in this state of the V4L3_ENABLE and V6L3_ENABLE bits being set to 1 (on). In this configuration, an L3 routing lookup is performed for data traffic that is received from the inter-NI link. Here is it again noted that in this embodiment, the inter-NI link includes two physical links (from port 440 to port 540 and from port 441 to port 541). The entry on the port table 525 applies to traffic received from NI-A on either link. In another embodiment (not shown), each port 540 and 541 have their own port table or own table entry for this purpose.

In the embodiment of FIG. 4, in this state, the L2 table 530 is configured with the chassis router MAC address being learned on CPU port 0 (not shown), and with routing enabled for traffic addressed to this router MAC. In this embodiment, an L3 bit on the L2 routing table 530 has been set to 1 (on). In this configuration, routing traffic bridged from NI-B is sent to the routing module 535 and, in this example, routed toward its destination on port B as illustrated by the broken lines and arrowheads. Ports x and y are also shown in FIG. 4 to illustrate that other ports may be and often are present, but they are not otherwise described herein.

When offloading of traffic from NI-A is no longer necessary or desirable, the configuration state of NI-A and NI-B, in this embodiment, is changed to that illustrated in FIG. 5. As can be seen in FIG. 5, the port table associated with port A of NI-A now has a route ENABLE bit set to 1. In an implementation using the BCM56630 or similar chipset, this is representative of the V4L3_ENABLE and V6L3_ENABLE bits set to 1 (on). This means that outing lookups are performed in NI-A for routing traffic received on port A in this configuration. Correspondingly, he L2 hardware routing table 430 is configured with a router-MAC entry associated with an L3 routing bit set at 1. In this configuration state, all routing traffic received, for example, at port A is passed to the routing module 435 and eventually forwarded toward its intended destination, in this example on port n, as represented by the broken lines and arrowheads in FIG. 5.

As should be apparent from FIG. 5, NI-A is no longer offloading routing traffic to NI-B, but instead performing the routing functions itself for traffic it receives on its own (NI-A) ports. Correspondingly, NI-B is no longer receiving routing traffic offloaded from NI-A, and, in this embodiment, has updated its IPort_Table 525 route ENABLE value to 0 (off). NI-B may, off course, continue routing L3 traffic received on any of its own ports x, y, or B, and for this reason may or may not update the L2 table previously set to ensure routing of bridged traffic. In many embodiments, this is a normal operating configuration state.

Finally, note that in a preferred embodiment NI-B may also, if necessary or desirable, offload its routing traffic to NI-A in an analogous fashion. In another embodiment (not shown), a third NI is present, and may be used for selectively offloading traffic as well. In such an embodiment, an NI may first determine which other NI is available and, perhaps, most suited for this purpose.

FIG. 6 is a simplified block diagram illustrating an NI 600 configured according to an embodiment of the present invention. NI 600 is similar though not necessarily identical to NI-A and NI-B of FIGS. 4 and 5. In the embodiment of FIG. 6, NI 600 includes a CPU 605 for controlling the modules and functions of the NI in accordance with the present invention, and a memory device 610 for storing data and software instructions used by the NI. Note that in alternate embodiments, the CPU and memory serving the NI 600 may be located outside the NI, and may in some instances serve other NIs in the multi-NI platform as well.

In the embodiment of FIG. 6, NI 600 also includes a number of ports on which data may be transmitted and received. In FIG. 6, these ports are represented by ports 601, 602, and 603. As implied in FIG. 6, additional data ports may be present. In a preferred embodiment, there is also present an inter-NI port 606, which is dedicated to inter-NI data transmissions. Specifically, the inter-NI port 606 in this embodiment communicates with other NIs in a multi-NI platform of which NI 600 is a component. (See FIGS. 1, 4, and 5.)

In this embodiment, each port is associated with a port table or port table entry, for example ports 601 though 603 are respectively associated with port tables 611 through 613. Port table (sometimes referred to herein as an iport table) 616 is associated with inter-NI port 606. Note that although shown separately, these port tables are not necessarily separate physical components; the same ports may be, and often are, served by separate entries on a single table. The port tables or table entries store information and flags related to their respective ports. In accordance with the present invention, for example, a port table may include a route enable bit indicating whether routing lookups should be performed for ingress traffic on the port.

In the embodiment of FIG. 6, routing software 615 is also available for the routing of L3 data traffic using routing module 635. An L2 table, preferable implemented in hardware, is updated when MAC addresses are to be associated with certain ports, and, as mentioned above, enables routing traffic to be offloaded by bridging to another NI (not shown).

In this manner the present invention provides a system and method for handling data traffic in a multi-NI platform environment by enabling the efficient offloading of data traffic from one NI to another, from which it can be routed when, for example, the first NI is temporarily or permanently unable to do so. Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. A method for handling data traffic in a multi-NI (network interface) routing platform, the method comprising:
determining that L3 traffic should be off-loaded from a first NI of the routing platform;
disabling L3 routing in the first NI;
configuring the first NI to bridge incoming L3 data traffic on a port associated with a second NI of the routing platform; and
configuring the second NI to route L3 traffic received on a port associated with the first NI.

2. The method according to claim 1, further comprising transmitting an offload notification message from the first NI to the second NI.

3. The method according to claim 1, wherein the determining that L3 traffic should be off-loaded is performed by the first NI during an initialization sequence.

4. The method according to claim 3, further comprising commencing the initialization sequence in the first NI.

5. The method according to claim 4, wherein the commencing the initialization sequence is performed following an outage of the first NI.

6. The method according to claim 1, wherein disabling L3 routing in the first NI comprises setting at least one routing enable bit in a port table to an off state.

7. The method according to claim 6, wherein setting at least one routing enable bit to an off state comprises turning off the V4L3_ENABLE bit and the V6L3_ENABLE bit in the port table.

8. The method according to claim 1, wherein configuring the first NI to bridge incoming L3 data traffic comprises associating a router MAC address with the port associated with the second NI in an L2 table.

9. The method according to claim 8, wherein configuring the first NI to bridge incoming L3 data traffic comprises setting an L3 bit associated with the router MAC address on the L2 table to 0.

10. The method according to claim 8, wherein configuring the second NI to route L3 traffic received on the port associated with the first NI comprises associating the router MAC address with a CPU port on an L2 table of the second NI.

11. The method according to claim 10, wherein configuring the second NI to route L3 traffic received on the port associated with the first NI comprises setting an L3 bit associated with the router MAC address on the second NI L2 table to 1.

12. The method according to claim 1, wherein the port associated with second NI is associated with an inter-NI link.

13. The method according to claim 12, wherein the inter-NI link comprises a plurality of physical links and the port associated with the second NI is a virtual port comprising one or more physical ports.

14. The method according to claim 12, wherein the port associated with the second NI is a HiGig™ port.

15. The method according to claim 1, further comprising determining that the off-loading of L3 traffic from the first NI should be terminated.

16. The method according to claim 15, further comprising enabling L3 routing in the first NI.

17. The method according to claim 16, enabling L3 routing in the first NI comprises setting at least one routing enable bit in a port table to an on state.

18. The method according to claim 16, wherein enabling L3 routing in the first NI comprises associating a router MAC address with a CPU port and setting an L3 bit associated with the router MAC address on an L2 table of the first NI.

19. A system for handling data traffic in a multi-NI platform, comprising:
a first NI configured to determine that L3 routing traffic received in the first NI should be offloaded;
a second NI configured to receive and route L3 routing traffic bridged from the first NI; and
a communication link between the first NI and the second NI for carrying the bridged traffic;
wherein the first NI disables routing upon determining that L3 routing traffic should be off-loaded and updates a first NI L2 table to associate a port of the communication link with a router MAC address.

20. The system according to claim 19, wherein the communication link is an inter-NI link.

21. The system according to claim 20, wherein the inter-NI link is a virtual link comprising a plurality of physical links.

22. The system according to claim 19, wherein the first NI and the second NI are mounted in a single chassis.

23. The system according to claim 19, where the L2 table of the first NI is a hardware table.
